(19) United States
(12) Patent Application Publication
(10) Pub. No.: US 2016/0179890 A1
(43) Pub. Date: Jun. 23, 2016

(54) METHODS AND A SYSTEM FOR HYBRID LARGE JOIN QUERY OPTIMIZATION

(71) Applicant: TERADATA US, INC., DAYTON, OH (US)

(72) Inventors: Kuorong Chiang, Cerritos, CA (US); Hien Trong To, Los Angeles, CA (US); Wei Tang, Torrance, CA (US)

(73) Assignee: TERADATA US, INC., DAYTON, OH (US)

(21) Appl. No.: 14/581,737

(22) Filed: Dec. 23, 2014

(51) Int. Cl. G06F 17/30

(52) U.S. Cl. CPC G06F 17/30466; G06F 17/30498; G06F 17/30389

(57) ABSTRACT

Sets of joins against relations in a query are identified. An optimal order for processing the joins is determined. The optimal order is then processed by an enhanced genetic algorithm to generate a second optimal order for processing the joins. The second optimal order is at least as good as the optimal order. The second optimal order is used when developing a query plan for processing the query in a Database Management System (DBMS).

### Background

Join Query Optimization (JQO) is a problem of finding the best join order of a join query based on cost. JQO is one of the most difficult problems in query optimization as the number of alternative plans to answer a query grows exponentially with the number of join operations involved in the query. Another challenge arises when various join methods have to be supported for individual join operations (e.g., nested-loop, merge, and hash joins) and diverse access paths for retrieving from relations (e.g., bitmap, b-tree, hash indexes). Current implementations of query optimizers are k-look-ahead algorithms (kLA) (i.e, k=2, 5), which perform recursive greedy searches over the search spaces. That is, the search generates the next logical expression for evaluation based on the result of the costing determined by the previous processing step. Such query optimization techniques are not ideal to support complex queries that involve a large number of relations (i.e., >=10). For those queries, kLA is often either bad in terms of the quality of the join plan (when k=2) or expensive to compute (when k=5).

Therefore, there is a need for improved solutions to the JQO problem.

### SUMMARY

In various embodiments, methods and a system for hybrid large join query optimization are presented. According to an embodiment, a method for optimizing a hybrid large join query is provided.

Specifically, all set permutations for join operations appearing in a query are identified. Next, a first optimal order for processing the join operations is determined. Then, a genetic algorithm is processed using the first optimal order and the set of permutations. A second optimal order for processing the join operations is received as output from the genetic algorithm.

### BRIEF DESCRIPTION OF THE DRAWINGS

FIG. 1 is a diagram depicting an encoded query graph, according to an example embodiment.

FIG. 2 depicts a diagram of a graph illustrating a crossover operator, according to an example embodiment.

FIG. 3 depicts a diagram of a graph illustrating mutation, according to an example embodiment.

FIG. 4 depicts a diagram of an example architectural setup, according to an example embodiment.

FIG. 5 depicts diagrams of graphs representing trade-offs between execution plan quality and processing execution time of the execution plan, according to an example embodiment.

FIG. 6 is a diagram of a method for optimizing a hybrid large join query, according to an example embodiment.

FIG. 7 is a diagram of another method for optimizing a hybrid large join query, according to an example embodiment.

FIG. 8 is a diagram of a hybrid large join query system, according to an example embodiment.

### DETAILED DESCRIPTION

It is to be noted that the techniques presented herein are implemented as executable instructions that are programmed in memory or non-transitory computer-readable storage media (or medium) for execution on one or more processing devices, each processing device having one or more processors, and each processor specifically configured to execute the executable instructions.

The techniques and system herein propose a new and novel approach to addressing the JQO problems. This is achieved by using a hybrid approach as an option for the query optimization problem. The first phase executes a kLA algorithm (k<5) whose best join order is used by a genetic algorithm as an individual of an initialized population. The proposed solution is guaranteed to be at least as good as kLA while provides some sort of randomness to avoid local optimization. Experimental results show that the proposed approach balances well the trade-off between plan quality and plan generation time.

To find the best join order, a query optimization uses a recursive greedy algorithm, namely k-look-ahead (kLA). First, kLA generates all possible k-set (i.e., each set includes k binary joins) from the relation set. Then, the best cost of each individual k-set is evaluated using an exhaustive search; the first binary join of the less costly k-set is committed and the two source relations of the binary join are replaced by the resulting join relation. kLA loops through the process until only one relation remains.

### Genetic Algorithm (GA)

Three fundamental approaches to Large JQO (LJQO) include heuristic, randomized and genetic algorithms. The genetic algorithm (GA) is a heuristic optimization method, which operates through randomized search. Genetic algorithms have been shown to generate high quality solutions within reasonable amount of time.

### Basic Concepts

1. GAs must have its solutions represented as data strings by an appropriate encoding.
2. GAs do not work on a single solution, but on a set of solutions, so called the population.
3. A single solution is called chromosome, represented as a string composed of characters (genes).
4. A Gene is a subsequence of a chromosome.
5. The fitness of a solution is of a solution that is measured according to an objective function that has to be maximized or minimized. A well-designed GA, both the average fitness and the fitness of the best solution increases with every new generation.

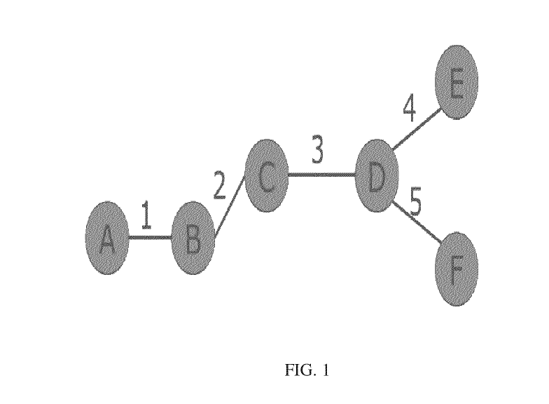

The GA is very similar to biological evolution in is search for good problem solutions. The basic idea is to start with a random population and generate offspring by random crossover and mutation. The “fittest” members of the population (according to the cost function) survive the subsequent selection; the next generation is based on these. The algorithm has a termination condition (e.g., there is no further improvement or after a predetermined number of generations). The fittest member of the last population is the solution. The interpretation of JQO problem as a GA problem is as follows:

| Join Query Optimization | GA Interpretation |
|---|---|
| An order of selecting binary joins, e.g., | Encoding |
| 32541 (FIG. 1) | |
| A join order | Chromosome |
| A subsequence of joining k relations, | Gene |
| e.g., 254 (k = 3) | |
| A set of N *different* join orders | Population |
| Estimated cost of the join plan (the | Fitness |
| smaller, the better) | |
| Subsequence/gene exchange | Recombination/Crossover |
| Swap two subsequences/genes | Mutation |
| Select best individuals for new | Selection |
| generation | |

FIG. 1 is a diagram depicting an encoded query graph for a sample scenario, according to an example embodiment.

Each circle in the diagram represents a relation. An order of selecting edges represents a solution.

### Enhanced GA for LJQO

In the first processing step (1), a population of random chromosomes is generated using random permutation. This is the “zero” generation of solutions. Then, each next generation is determined.

In the second processing step (2), a certain fraction of the fittest members of the population is combined yielding offspring (crossover) using fitness proportionate selection. This step combines partially good solutions in order to obtain a superior result. Subsequence exchange is used, in which, a random subsequence in each of the two offspring chromosomes is permuted according to the genes' order of appearance in the other parent.

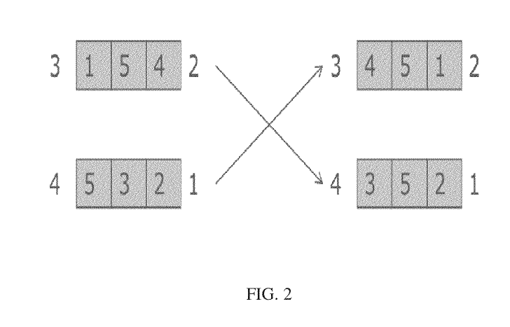

FIG. 2 depicts a diagram of a graph illustrating a crossover operator, according to an example embodiment.

At the beginning of crossover, individuals in the current generation with the best fitness values are selected; so called elite children. These individuals automatically survive to the next generation to guarantee best individuals do not disappeared as the result of crossover and mutation.

In the third processing step (3), a certain fraction of the population (not necessarily the fittest) is altered randomly (mutation). This processing step introduces features that are not present in any member of the population. Mutation is carried out by random alternation of a randomly selected chromosome.

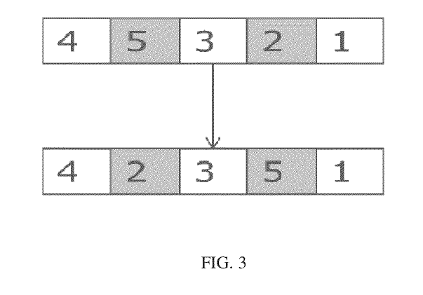

FIG. 3 depicts a diagram of a graph illustrating mutation, according to an example embodiment.

With ordered list encoding (see FIG. 1); the novel implementation of mutation, is as graphically illustrated in FIG. 3. Two random genes are simply swapped in order to carry out the mutation.

In the fourth processing step (4), a certain fraction of the fittest members of the population, including elite children (from the processing step (2)) is propagated into the next generation (selection). The purpose of this step is to remove bad solutions and increase the share of good solutions. The selection scheme is based on the fitness ratio of the members of the population: the better a member satisfies the objective function, the more it dominates the wheel. To avoid disappearance of bad solutions' features, ranking-based selection is used. This means it is not the value of the objective function itself but its rank that is used for biasing the selection wheel.

Note that the population has to be distinct. Correspondingly, the processing steps (2)-(4) are iterated until a termination condition is satisfied. The enhanced GA stops when one of the following conditions holds true:
1) A certain predetermined number of generations have been produced.
2) A time limit has been reached.
3) No improvement has been observed for a certain number of generations. Hybrid Approach

The hybrid algorithm (presented herein) combines kLA (i.e., deterministic) and genetic (i.e., semi-randomized) algorithms. The best result obtained by kLA is used as one initial member for the enhanced GA, which helps the enhanced GA to converge towards better query plans faster and more efficiently (optimally).

The cost to execute a join query comprises of two parts, the parsing time (time to run the query planning algorithm) and the execution time (the actual time to execute the query). The parsing time combined with the execution time is referred to as the elapsed time. As it is not possible to achieve the execution time during planning, an estimated execution time is calculated as the multiplication of estimated cost with a coefficient. The execution time component is considered by adding a termination condition. That is, the hybrid algorithm stops if the current elapsed time exceeds the sum of the elapsed time and the estimated time of kLA algorithm.

### Tested Results

The initial selected parameters were set as follows (it is noted that this is one example other values and parameters may be used as well without detracting from the teachings presented herein):

| Parameters | Value |
|---|---|
| The maximum number of generations | 400 |
| Population size | 200 |
| The number of children produced by | 300 |
| crossover | |
| The faction of the population that are elite | 5% |
| children | |
| The fraction of the population that participate | 60% |
| in crossover | |
| The fraction of the population that participate | 5% |
| in mutation | |
| The maximum number of no improvement | 100 |
| has been observed | |
| The length of exchanged subsequence | 3 |
| (genes' length) | |

An emulated environment was created based on a TPC-DS benchmark, including 24 tables (7 fact tables and 17 dimension tables). We evaluated the algorithms by estimated costs. To evaluate the cost of a plan, we developed a simplified model for binary join costing (details of which are out of the scope of this invention). Given two relations and their statistics obtained from the Transaction Processing Council (TPC) Data Support (DS) (TPC-DS) benchmark (TPC Benchmark™ DS), the model outputs the best binary join plan, including the minimum estimated cost, the best join method (i.e., merge, hash) and the best geography strategy (i.e., local, hash, duplicate).

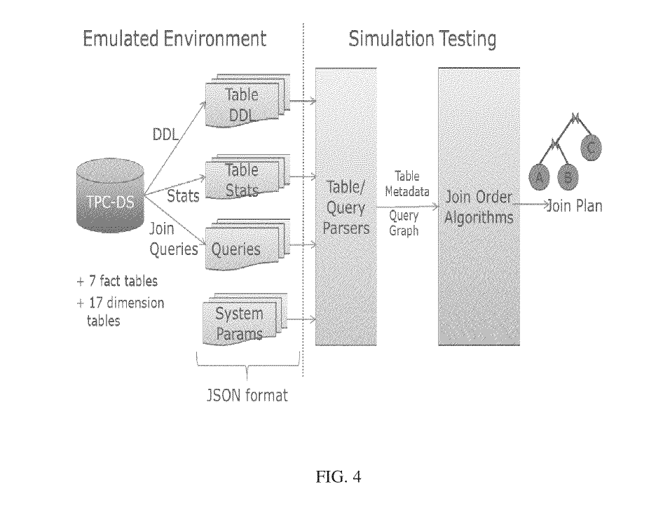

FIG. 4 depicts a diagram of an example architectural setup, according to an example embodiment used for testing.

Based on foreign key references of the tables, 50 uniform query graphs of size 24 (i.e., all tables are involved in join queries) were generated using random walks.

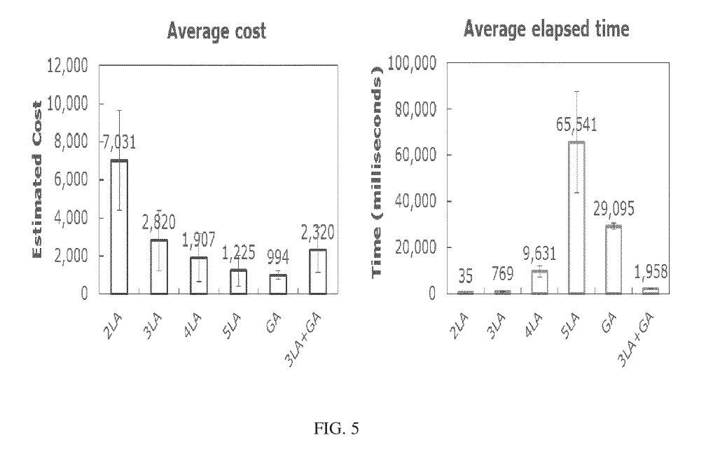

FIG. 5 depicts diagrams of graphs representing trade-offs between query execution plan quality and processing execution time of the execution plan, according to an example embodiment produced from testing.

FIG. 5 presents the experimental results. The hybrid approach (3LA+GA) is shown to well balance the trade-off between plan quality (lower cost indicates better query plan) and algorithm execution time when compared to kLA and GA. The GA provides the best plan while 2LA is fastest to execute.

Using the hybrid approach to solving query optimization problems is a novel and superior approach from what is presently available in the industry given the well-balanced tradeoff shown in the experimental results (FIG. 5).

In an embodiment, the algorithm is parallelized to speed up the execution using modern multi-core processors.

In an embodiment, a virtual Access Module Processor (AMP) processes in a Relational Database Management System (RDBMS) as agents to do join planning independently. This improves query parsing time.

The methods and system herein for a hybrid LJQO solution provides a variety of benefits, such as and by way of example only:
1. The proposed solution is based on greedy (i.e., KLA) and genetic algorithms, which have been extensively studied and proven.
2. The hybrid approach merits two approaches, deterministic and randomized algorithms. It guarantees that the join plan result is at least as good as the deterministic approach (i.e., in terms of estimated cost) while the later randomized phase add some randomness to the solution space which can escape from local optimization.
3. The hybrid approach balances the trade-off between estimated cost and elapsed time.

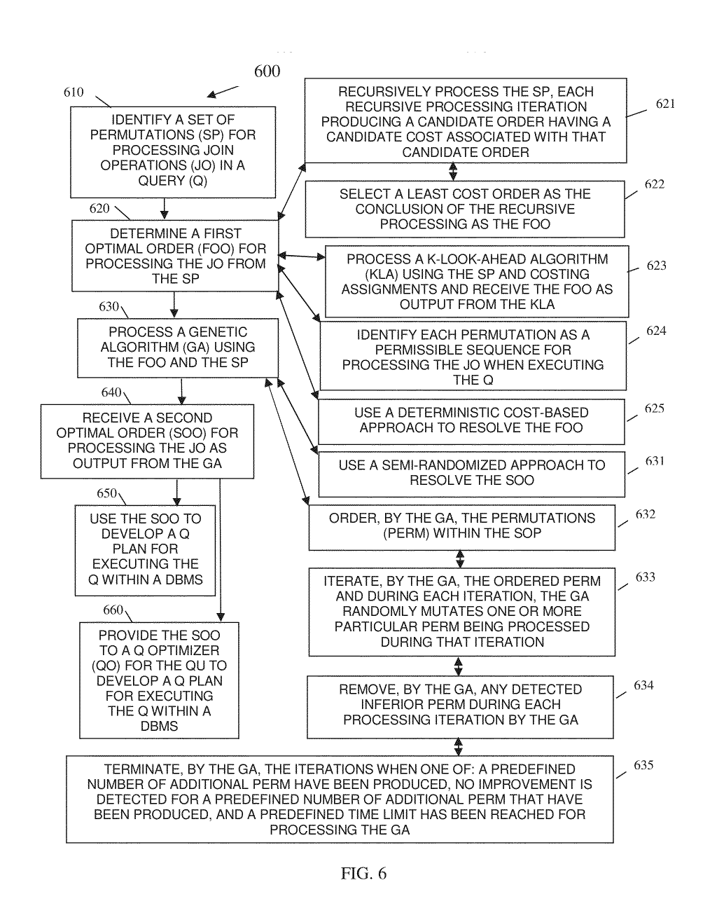

These embodiments and other embodiments are now further presented with reference to FIGS. 6-8.

FIG. 6 is a diagram of a method 600 for optimizing a hybrid large join query, according to an example embodiment. The method 600 (hereinafter “hybrid join query optimizer”) is implemented as executable instructions that are programmed and reside within memory and/or non-transitory computer-readable storage media for execution on one or more processing nodes (processors) of a network; the network wired, wireless, and/or a combination of wired and wireless.

The processor that executes the hybrid join query optimizer is part of a Database Management System (DBMS) architecture.

In an embodiment, the processor that executes the hybrid join query optimizer is part of a RDBMS architecture.

In an embodiment, the RDBMS architecture is a massively parallel distributed environment.

In an embodiment, the hybrid join query optimizer implements, inter alia, at least some of the processing discussed above with respect to FIGS. 1-5.

In an embodiment, the hybrid join query optimizer is part of a query optimizer of a DBMS.

In an embodiment, the hybrid join query optimizer interacts with a query optimizer to facilitate developing a query plan for executing a query within a DBMS.

At 610, the hybrid join query optimizer a set of permutations for processing join operations appearing in a query.

At 620, the hybrid join query optimizer determines a first optimal order for processing the join operations from the set of permutations.

According to an embodiment, at 621, the hybrid join query optimizer recursively processes the set of permutations. Each recursive processing step produces a candidate order having a candidate cost associated with that candidate order.

In an embodiment of 621 and at 622, the hybrid join query optimizer selects a least cost order at the conclusion of the recursion as the first optimal order.

In an embodiment, at 623, the hybrid join query optimizer processes a k-look-ahead algorithm using the set of permutations and costing assignments and receives the first optimal order as output from the k-look-ahead algorithm.

In an embodiment, at 624, the hybrid join query optimizer identifies each permutation from the set of permutations as a permissible sequence for processing the join operations when executing the query.

In an embodiment, at 625, the hybrid join query optimizer uses a deterministic cost-based approach to resolve the first optimal order.

At 630, the hybrid join query optimizer processes a genetic algorithm using the first optimal order and the set of permutations. In an embodiment, the genetic algorithm is the genetic algorithm discussed above with reference to FIGS. 1-5.

According to an embodiment, at 631, the hybrid join query optimizer processes the genetic algorithm as a semi-randomized approach to resolve the second optimal order.

In an embodiment, at 632, the genetic algorithm orders the permutations within the set of permutations.

In an embodiment of 632 and at 633, the genetic algorithm iterates the ordered permutations and during each iteration step, the genetic algorithm randomly mutates one or more particular permutations being processed during that iteration step.

In an embodiment of 633 and at 634, the genetic algorithm removes any detected inferior permutations during each iteration step.

In an embodiment of 634 and at 635, the genetic algorithm terminates the iteration processing when one of: a predefined number of additional permutations have been produced, no improvement is detected for a predefined number of additional permutations that have been produced, and a predefined time limit has been reached for processing the genetic algorithm.

At 640, the hybrid join query optimizer receives a second optimal order for processing the join operations as output from the genetic algorithm.

According to an embodiment, at 650, the hybrid join query optimizer uses the second optimal order to develop a query plan for executing the query within a DBMS. Here, the hybrid join query optimizer is part of or an enhanced feature of a query optimizer associated with the DBMS.

In an embodiment, at 660, the hybrid join query optimizer provides the second optimal order to a query optimizer for the query optimizer to develop a query plan for executing the query within the DBMS. Here, the hybrid join query optimizer is a callable procedure accessible to and called by the query optimizer but not necessarily part of the query optimizer.

Note that the second optimal order is at least as good as the first optimal order in terms of query processing cost when executing the query in the DBMS.

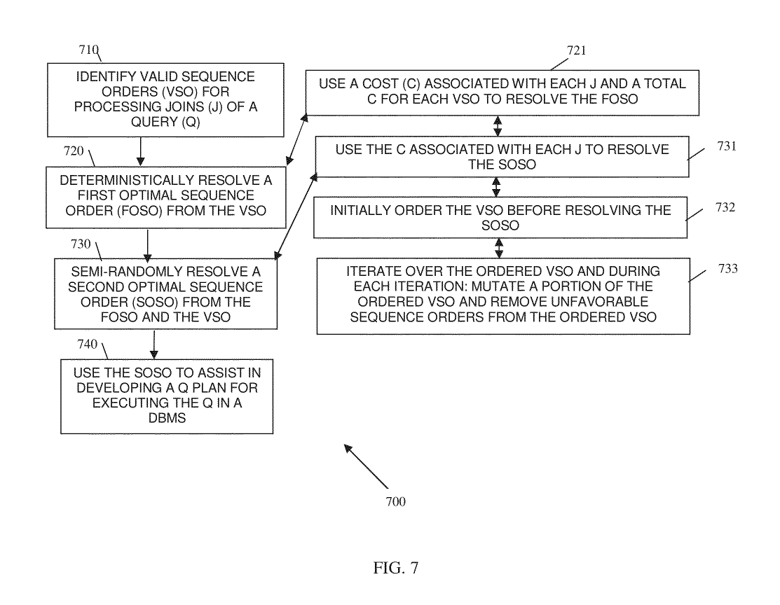

FIG. 7 is a diagram of another method 700 for optimizing a hybrid large join query, according to an example embodiment. The method 700 (hereinafter “join optimizer”) is implemented as executable instructions within memory and/or non-transitory computer-readable storage media that execute on one or more processors of a device, the processors specifically configured to execute the join optimizer. The join optimizer is also operational over a network; the network is wired, wireless, or a combination of wired and wireless.

In an embodiment, the processor(s) that execute the join optimizer are part of a DBMS.

In an embodiment, the processor(s) that execute the join optimizer is part of a RDBMS.

In an embodiment, the join optimizer executes within a distributed parallel distributed processing environment and architecture.

In an embodiment, the distributed parallel processing environment is a massively parallel distributed RDBMS.

In an embodiment, the join optimizer implements, inter alia, at least some of the processing discussed above with respect to FIGS. 1-5.

In an embodiment, the join optimizer is part of a query optimizer of a DBMS.

In an embodiment, the join optimizer interacts with a query optimizer to facilitate developing a query plan for executing a query within a DBMS.

In an embodiment, the join optimizer presents another and enhanced processing perspective of FIG. 6.

At 710, the join optimizer identifies valid sequence orders for processing joins of a query. Each valid sequence order is logically equivalent to remaining valid sequence orders, which means any of the valid sequence orders can be processed by the query to yield the same query results.

At 720, the join optimizer deterministically resolves a first optimal sequence order from the valid sequence orders. Optimal in terms of query processing time and resource usage when processing the joins within the query.

According to an embodiment, at 721, the join optimizer uses a cost (processing time and/or resource usage) with each join and a total cost for each of the valid sequence orders to resolve the first optimal sequence order.

At 730, the join optimizer semi-randomly resolves a second optimal sequence order from the first optimal sequence order and the valid sequence orders.

In an embodiment of 721 and 730, at 731, the join optimizer uses the cost associated with each join to resolve the second optimal sequence order.

In an embodiment, at 732, the join optimizer initially orders the valid sequence orders before resolving the second optimal order.

In an embodiment of 732 and at 733, the join optimizer iterates over the ordered valid sequence orders and during each iteration step: mutates a portion of the ordered valid sequence orders and removes unfavorable sequence orders from the ordered valid sequence orders.

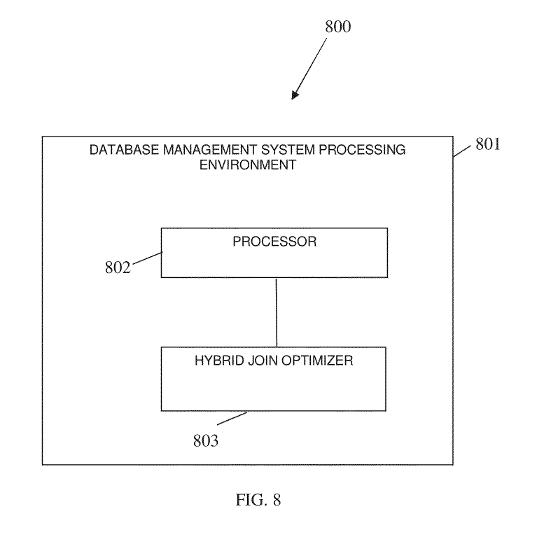

FIG. 8 is a diagram of a hybrid large join query system 800, according to an example embodiment. Some components of the hybrid large join query system 800 are implemented as executable instructions that are programmed and reside within memory and/or non-transitory computer-readable storage medium that execute on one or more processors of a network. The network is wired, wireless, or a combination of wired and wireless.

In an embodiment, hybrid large join query system 800 implements, inter alia, the techniques presented above with respect to the discussions relevant to FIGS. 1-5.

In an embodiment, the hybrid large join query system 800 implements, inter alia, the techniques presented above with the method 600 of FIG. 6.

In an embodiment, the hybrid large join query system 800 implements, inter alia, the techniques presented above with the method 700 of FIG. 7.

In an embodiment, the hybrid large join query system 800 implements, inter alia, the techniques presented above with the methods 600 of FIG. 6 and the methods 700 of FIG. 7.

The hybrid large join query system 800 includes a DBMS processing environment 801 having at least one processor 802, and a hybrid join optimizer 803.

In an embodiment, the DBMS 801 is part of a Relational Database Management System (RDBMS).

The hybrid join optimizer 803 is configured to: execute on the at least one processor 802, deterministically resolve a first optimal sequence order for processing joins of a query, semi-randomly resolve a second optimal sequence order for processing the joins of the query, and use the second optimal sequence order to develop a least a portion of a query plan for executing the query within the DBMS processing environment.

According to an embodiment, a first cost of executing the first optimal sequence order within the query is greater than or equal to a second cost of executing the second optimal sequence order within the query.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

1. A method, comprising:
identifying, by a processor, a set of permutations for processing join operations appearing in a query;
determining, by the processor, a first optimal order for processing the join operations from the set of permutations;
processing, by the processor, a genetic algorithm using the first optimal order and the set of permutations;
receiving, by the processor, a second optimal order for processing the join operations as output from the genetic algorithm.

2. The method of claim 1 further comprising, using the second optimal order to develop a query plan for executing the query within a Database Management System (DBMS).

3. The method of claim 1 further comprising, providing the second optimal order to a query optimizer for the query optimizer to develop a query plan for executing the query within a Database Management System (DBMS).

4. The method of claim 1, wherein determining further includes recursively processing the set of permutations, each recursive processing iteration producing a candidate order having a candidate cost associated with that candidate order.

5. The method of claim 2, wherein recursively processing further includes selecting a least cost order at the conclusion of the recursive processing as the first optimal order.

6. The method of claim 1, wherein determining further includes processing a k-look-ahead algorithm using the set of permutations and a costing assignments and receiving the first optimal order as output from the k-look-ahead algorithm.

7. The method of claim 1, wherein determining further includes identifying the each permutation from the set of permutations as a permissible sequence for processing the join operations when executing the query.

8. The method of claim 1, wherein determining further includes using a deterministic cost-based approach to resolve the first optimal order.

9. The method of claim 1, wherein processing further includes processing the genetic algorithm as a semi-randomized approach to resolve the second optimal order.

10. The method of claim 1, wherein processing further includes ordering, by the genetic algorithm, the permutations within the set of permutations.

11. The method of claim 10, wherein processing further includes iterating, by the genetic algorithm, the ordered permutations and during each processing iteration the generic algorithm randomly mutates one or more particular permutations being processed during that iteration.

12. The method of claim 11, wherein processing further includes removing, by the genetic algorithm, any detected inferior permutations during each processing iteration by the genetic algorithm.

13. The method of claim 12, wherein processing further includes terminating, by the genetic algorithm, the iterations when one of: a predefined number of additional permutations have been produced, no improvement is detected for a predefined number of additional permutations that have been produced, and a predefined time limit has been reached for processing the genetic algorithm.

14. A method, comprising:
identifying, by a processor, valid sequence orders for processing joins of a query;
deterministically resolving, by the processor, a first optimal sequence order from the valid sequence orders;
semi-randomly resolving, by the processor, a second optimal sequence order from the first optimal sequence order and the valid sequence orders; and
using, by the processor, the second optimal sequence order to assist in developing a query plan for executing the query in a Database Management System (DBMS).

15. The method of claim 14, wherein deterministically resolving further includes using a cost associated with each join and a total cost for each of the valid sequence orders to resolve the first optimal sequence order.

16. The method of claim 15, wherein semi-randomly resolving further includes using the cost associated with each join to resolve the second optimal sequence order.

17. The method of claim 14, wherein semi-randomly resolving further includes initially ordering the valid sequence orders before resolving the second optimal sequence order.

18. The method of claim 17, wherein initially ordering further includes iterating over the ordered valid sequence orders and during each processing iteration: mutating a portion of the ordered valid sequence orders and removing unfavorable sequence orders from the ordered valid sequence orders.

19. A system, comprising:
a processor within a Database Management System (DBMS) processing environment; and
a hybrid join optimizer configured to: i) execute on the processor, ii) deterministically resolve a first optimal sequence order for processing joins of a query, iii) semi-randomly resolve a second optimal sequence order for processing the joins of the query, and iv) use the second optimal sequence order to develop a least a portion of a query plan for executing the query within the DBMS processing environment.

20. The system of claim 19, wherein a first cost of executing the first optimal sequence order within the query is greater than or equal to a second cost of executing the second optimal sequence order within the query.
